(19) United States
(12) Patent Application Publication
(10) Pub. No.: US 2004/0032949 A1
(43) Pub. Date: Feb. 19, 2004

(54) Hill system or scrambler system

(76) Inventor: Richard Forest, Santa Rosa, CA (US)

Correspondence Address: Richard Forest, 1007 Humboldt St., Santa Rosa, CA, 95404, US

(21) Appl. No.: 10/219,895

(22) Filed: Aug. 14, 2002

(51) Int. Cl. H04K 1/00

(52) U.S. Cl. 380/28

(57) ABSTRACT

Techniques are provided for improvement of the modulo-26 Hill system that encrypts a limited character set in blocks of two, and for expanding its original polygraphic capability into a polygraphic/polymorphic modulo-256 system to be known as the “Scrambler” system. Methods are provided so that the new system will encrypt in blocks of potentially any size and will be capable of encrypting any computer file into random-appearing ciphertext containing a variable length from approximately 30 to 130 characters larger than the original plaintext. The encrypted file will be any of a very large number of possible random-appearing ciphertext patterns. The improved system is invulnerable to all known forms of cyptanalysis, including simple brute-force key searches or sophisticated known-plaintext attacks, hides repeating plaintext patterns of any length, and it resists traffic analysis.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A COMPUTER PROGRAM LISTING COMPACT DISC APPENDIX

An appendix submission on compact disc is made of a working prototype of the system described by this specification. The appendix submission is a computer program listing made in accordance with Sections 1.52, 1.77 (e)(4) and 1.96 of the Consolidated Patent Rules. The total number of compact discs including duplicates is 2.

### Identification of Each Compact Disc by List of Files Contained on Submitted Discs (Consolidated Patent Rules Section 1.52(e)(5))

| File Name | Date of Creation | Size in Bytes |
|---|---|---|
| scramb˜1.exe | Aug. 11, 2002 | 1,093,632 |
| c03k0001.txt | Feb. 13, 2002 | 17 |
| d03k0001.txt | Mar. 25, 2002 | 17 |
| c03k0002.txt | Feb. 13, 2002 | 17 |
| d03k0002.txt | Mar. 22, 2002 | 17 |
| c05k0001.txt | Mar. 31, 2002 | 33 |
| d05k0001.txt | Mar. 31, 2002 | 33 |
| c14k0001.txt | Apr. 06, 2002 | 204 |
| d14k0001.txt | Apr. 11, 2002 | 204 |
| c14k0002.txt | Apr. 14, 2002 | 204 |
| d14k0002.txt | Apr. 14, 2002 | 204 |
| c19k0001.txt | Apr. 17, 2002 | 369 |
| d19k0001.txt | Apr. 21, 2002 | 369 |
| c24k0001.txt | Apr. 24, 2002 | 584 |
| d24k0001.txt | Apr. 25, 2002 | 584 |
| c25k0001 txt | Apr. 25, 2002 | 633 |
| d25k0001.txt | Apr. 30, 2002 | 633 |
| c25k0002 txt | May 08, 2002 | 633 |
| d25k0002.txt | May 10, 2002 | 633 |
| c26k0001.txt | May 15, 2002 | 684 |
| d26k0001.txt | May 17, 2002 | 684 |
| c30k0001.txt | May 20, 2002 | 908 |
| d30k0001.txt | Jul. 12, 2002 | 908 |
| sk0001 txt | Feb. 19, 2002 | 266 |
| sk0002 txt | Feb. 19, 2002 | 266 |
| sk0003.txt | Feb. 19, 2002 | 266 |

### BACKGROUND OF THE INVENTION

This invention relates to cryptographic improvements to the Hill system, an apparently unpatented system in the public domain. In the 1920's, mathematician Lester S. Hill created an algebraic polygraphic encryption system based on second order (2 by 2) Modulo 26 matrices as keys created in matching-key pairs, one to encrypt and the other to decrypt. The keys are interchangeable; what either key in the pair encrypts, the other will decrypt The encryption system is known as the “Hill system” and is accepted universally as such today

### References

### US PATENT DOCUMENTION

Not Applicable (None known)

### Other References

Encyclopedia Americana International Edition, 2002 Edition, Volume 8, pp. 279-280 is the only current summary citation of the Hill system and describes the system thusly:

“The most general polygraphic system, which can encrypt dozens of letters at a time, is the Hill system Invented by American mathematician Lester Sanders Hill (1890-1961), it employs algebraic equations in modulo 26 It defends itself well against cryptanalysis but is too cumbersome for practical use”

This current encyclopedia statement summarizes the present known state of the Hill system: the most general polygraphic system, a system existing within the public domain, has never been considered useful within the meaning of 35 USC section 101; no prior innovations or improvements to the original system are known.

### Descriptions

The basic Hill system polygraphic encoding algorithm (written here in Microsoft Visual Basic 6.0 format) confirms that the Hill system algorithm encoding key encodes an entire plaintext file of alphabetic characters into polygraphic ciphertext. Conversely, its decoding algorithm simply replaces the encoding key with the decoding key.

ALGORITHM A

| | |
|---|---|
| Private Sub c1cipher | ′ The Hill cipher algorithm set to cipher a message. |

| | |
|---|---|
| *For I = 1 To p1length Step 2 | ′ p1length is plaintext file length. Block length is 2. |
| *For row = 1 To 2 | ′ Lower-case alphabetic begins at numeric value 97. |

| | |
|---|---|
| *cd multiply(row) = Asc(Mld(p1text, I + row − 1)) − 96 | ′ A block of alphabetic plaintext |

| | |
|---|---|
| Next row | ′ string is converted to a block of its equivalent |
| * For row = 1 to 2 | ′ numeric value for encryption purposes. |
| tempadd = 0 | |
| *For column = 1 To 2 | |

| | |
|---|---|
| tempadd = tempadd + cdmultiply(column) * c1key(row, column) | c1key is |

| | |
|---|---|
| Next column | ′ a modulo 26 encryption key. |

*tempadd = tempadd Mod 26 ′ The algorithm is set for modulo 26 encryption.

| | |
|---|---|
| *Mid (p1text, I + row − 1, 1) = Chr(tempadd + 96) | ′ New ciphertext is converted back |

| | |
|---|---|
| Next row | ′ to alphabetic format. |
| Next I | ′ End of block |
| End sub | ′ End of algorithm |

*All asterisks at the left indicate places where improvement changes in the Hill system will be shown in Algorithm B.

The Hill system limitations (specific problems involved in the prior art).

1. Uses only 2nd order (2 by 2 matrix) modulo 26 matching-key pairs, is vulnerable to brute-force key-search attack.

2. Only 42% of modulo 26 potential keys are actual keys.

3. Limited size of a useable modulo 26 character set (26 characters) is incompatible with computers.

4. Requires internal conversion tables to handle the full modern computer character set (256 characters)

5 A modulo 26 system using internal tables always creates ciphertext at least twice the size of the plaintext.

6. The speed of a system using internal tables is slow.

7. The polygraphic system is unable to hide repeating plaintext patterns larger than the size of a block.

8. It is vulnerable to known-plaintext attacks.

9. It is only a polygraphic system. Any given plaintext produces only one possible ciphertext

### BRIEF SUMMARY OF THE INVENTION

Improvements on the polygraphic Hill system overcome the stated limitations A new version (Algorithm B ) of the original Hill algebraic algorithm (Algorithm A ) conforms to the requirements of modern computers, and sophisticated subalgorithms are added to the the basic new algorithm. These collective improvements create a useful new general encryption system displaying extraordinary polymorphic properties. The useful improvements of the Hill system are hereinafter identified as the “Scrambler” system.

### BRIEF DESCRIPTION OF THE SEVERAL VIEWS OF THE DRAWING

Not Applicable

### DETAILED DESCRIPTION OF THE INVENTION USEFUL HILL SYSTEM IMPROVEMENTS

Scrambler:

1. Uses larger modulo 256 matching-key pairs with much larger key spaces. It is not vulnerable to brute-force key-search attack.

2. 50% of modulo 256 potential keys are actual keys.

3. Can cipher 100% of the modern-computer ASCII character set; will cipher text, graphics, even .exe files.

4. Does not need internal conversion tables

5. Does a basic one for one conversion between plaintext and ciphertext with only a variable number of added characters to create variable-length padding that resists traffic analysis.

6. Is not slowed by use of internal conversion tables

7. Will hide repeating plaintext patterns of any length.

8. Is not vulnerable to known-plaintext attack.

9. Is a general polygraphic/polymorphic system capable of turning plaintext into any of millions or billions of ciphertext possiblities.

The Scrambler system will perform polygraphic encryption with all available characters in the modern computer 8-bit set as well as perform polymorphic encryption. The Scrambler system or Improved Hill system basic polygraphic algorithm is:

ALGORITHM B

| | |
|---|---|
| Private Sub c1 cipher | ′ improved algorithm set to cipher a file; p1length is the |

| | |
|---|---|
| * For I = 1 To p1length Step c1order | ′ plaintext file length; c1order is the key size. |
| * For row = 1 to c1order | ′ c1order can be equal to the largest-size key available |

| | |
|---|---|
| *cdmultiply(row) = Asc(Mid(p1text, I + row − 1, 1)) | ′ a block of plaintext string is |

| | |
|---|---|
| Next row | ′ converted to its equivalent numeric value |
| * For row = 1 To c1order | |
| * For column = 1 to c1order | |

tempadd = tempadd + cdmultiply(column)*c1key(row, column)) ′ c1key is a modulo 256

| | |
|---|---|
| Next column | ′ encryption key. cdmultiply is a block of plaintext |
| * tempadd = tempadd Mod 256 | ′ set for modulo 256 encryption |
| * Mid(p1text, I + row − 1, 1)) = Chr(tempadd) | ′ No conversion to alphabetic |
| Next row | ′ characters is necessary. |
| Next I | ′ End of block. |
| End Sub | ′ End of algorithm. |

* All asterisks at the left indicate improvements to the Hill system (Algorithm A)

TABLE OF IMPROVED HILL SYSTEM
POLYGRAPHIC/POLYMORPHIC KEY SPACES

| Key Order | Key Bit Size | Potential Key Space |
|---|---|---|
| 3 | 72 | 4,722,366,482,869,645,213,696 |
| 4 | 128 | 3.4 × 10 38 |
| 5 | 200 | 1.6 × 10 60 |
| 6 | 288 | 4.97 × 10 86 |
| 7 | 392 | 1.0 × 10 118 |
| 8 | 512 | 1.34 × 10 154 |
| 9 | 648 | 1.16 × 10 195 |
| 10 | 800 | 6.66 × 10 240 |
| 11 | 968 | 2.49 × 10 291 |
| 12 | 1152 | 6.11 × 10 346 |
| 13 | 1352 | 9.83 × 10 406 |
| 14 | 1568 | 1.03 × 10 472 |
| 15 | 1800 | 7.14 × 10 541 |
| 16 | 2048 | 3.23 × 10 616 |
| 17 | 2312 | 9 57 × 10 695 |
| 18 | 2592 | 1.86 × 10 780 |
| 19 | 2888 | 2.36 × 10 869 |
| 20 | 3200 | 1 97 × 10 963 |
| 21 | 3528 | 1.08 × 10 1062 |
| 22 | 3872 | 3.87 × 10 1165 |
| 23 | 4232 | 9.09 × 10 1273 |
| 24 | 4608 | 1.4 × 10 1387 |
| 25 | 5000 | 1.412 × 10 1505 |
| 26 | 5408 | 9.33 × 10 1627 |
| 27 | 5832 | 4 × 10 1755 |
| 28 | 6272 | 1 148 × 10 1888 |
| 29 | 6728 | 2.138 × 10 2025 |
| 30 | 7200 | 2.6 × 10 2167 |
| *Note: | | |
| The Hill system potential key space is 456, 976 keys; its actual key space is 42% of the potential space. The actual key space for each improved-system key size is 50% of the potential key space. Hill-type keys are two-dimensional. Each row in the right column is 256 to the power of the square of the row in the left column, or two to the power of the row in the middle column; this determines the potential key space for each size. The above | | |
| # table is based on polygraphic matching-key pairs that can be made in less than a week of computer time on the most powerful personal computers currently available. | | |

Scrambler system substitution key actual key space.

256!=8.57×10 506 DES (old Data Encryption Standard) 56-bit 7.205×10 16 NES (New Encryption Standard) 256-bit 1.1579×10 77 Possible Enigma settings 3×10 114

Note: Enigma was the electromechanical coding machine used by the German armed forces during World War II. It was more powerful than many systems in use today. It was regularly modified and then due to the carelessness of its users regularly broken by the British code-breakers at Bletchley Park.

### A Practical Method for Creating A Polymorphic Encryption System

Definitions:

A polygraphic encoding system is one that encodes two or more characters as a unit; a change in any one plaintext character changes the encipherment of the entire unit.

The term polymorphic is derived from the Greek polymorphos, meaning multiform. A variable-ciphertext-length polymorphic encryption system is one in which the ciphertext product of a given plaintext can assume any of many different possible random-appearing patterns and lengths. The decrypted product of many different ciphertext patterns can all be a single plaintext message

The Scrambler system is both polygraphic and polymorphic, having been built upon the improved polygraphic algorithm (Algorithm B), and comprises the following list of new principles of optimal polymorphic encryption.

1. The built-upon system must be a polygraphic-block system. If a plaintext file length is not a multiple of the block length, blank characters (spaces; ascii value 32) are added to the end of the file to fill the last block before encoding. When decoding is complete, any and all blank characters are removed from the end of the file.

2. When encoding, one or more general characteristics from each plaintext block, such as the cumulative ascii value of all characters in the block or a characteristic related to the position of the block in the file must be captured before ciphering, added to a running total, and the running total stored as additions to one or more places in the next block before it is encoded through the polygraphic algorithm. When decoding these changes are removed from the block after it is decoded through the polygraphic algorithm. These processes can be added to Algorithm A or to Algorithm B. Encryption and decryption can be done in a single algorithm in the polygraphic mode, only the keys are changed. The polymorphic mode requires two separate algorithms; one for encryption and one for decryption.

3. When encoding or decoding, Principle 2 requires the first block be initiated with starting vectors—that can be controlled, varied, and stored—serving as pseudo-characteristics to start the process. The starting vectors affect the pattern of the entire ciphertext file

4. The ciphertext must be double-padded at both ends. There must be a random inner plaintext padding, and a random-appearing outer ciphertext padding. The inner padding is added first before encoding, removed last after decoding.

4. (a) The inner padding is encoded and decoded with the rest of the plaintext; the inner padding at both ends have variable lengths (maximum and minimum lengths), and factors determining the variable lengths of the front and back inner padding are stored somewhere within the minimum length of the inner paddings, so these are stored as encrypted information. The length factors can be stored as any of the 256 possible computer characters, but the actual lengths can be a combination of the minimum length plus an X modulo (Mod arithmetic operator) of the stored character numeric value, so minimum plus X create a maximum inner padding length. The inner padding is added before encoding, removed after decoding. Principle 2 will cause characteristics of the randomly-generated inner padding at the beginning of the file to influence the encrypted pattern of the entire file; any change in the beginning padding will change the encipherment of the entire file. The last character of the inner padding at the end of the file should not be a space (ascii value 32), see Principle 1.

4. (b) The outer padding is created before encoding, but added after encoding; it is analyzed and removed before deciphering. The random-appearing outer padding is created before ciphering because it contains information needed to cipher and decipher the file properly, such as the places where information is added to a block in principle 2; start vector factors (Principle 3) can be stored in the outer padding and/or the encoding or decoding key.

4. (c) The outer padding should consist of a variable-length (dynamic) pad and a fixed-length (static) pad. Information stored in the outer padding should be stored within the minimum length of the static pad; it should be stored on the side of the static pad that is next to the inner pad. The dynamic pad has a randomly-generated length anywhere from zero to one less than the block length; its length will vary with each encryption The static pad should have a minimum and maximum possible length; the factor determining its actual length can be stored in the encryption or decryption key; the static-pad length will vary only with the key, if the factor determining the actual length is in the encryption key, both keys must be loaded when decoding; if the factor determining the actual length is in the decryption key, both keys must be loaded when encoding. Before decoding, the static pad is removed first, then the dynamic pad; the dynamic pad is snipped off using the “Mod” arithmetic operator. After the outer pads at both ends are removed, the remainder is a ciphertext file whose length is a multiple of the block length.

TABLE OF IMPROVED HILL SYSTEM
POLYMORPHIC POTENTIAL

| Key Order | Key Bit Size | # of different potential ciphertext files |
|---|---|---|
| 3 | 72 | 100,663,296 |
| 4 | 128 | 402,653,184 |
| 5 | 200 | 1,006,632,184 |
| 6 | 288 | 2,013,265,920 |
| 7 | 392 | 3,523,215,360 |
| 8 | 512 | 5,637,144,576 |
| 9 | 648 | 8,455,716,864 |
| 10 | 800 | 12,079,595,520 |
| 11 | 968 | 16,609,443,840 |
| 12 | 1152 | 22,145,925,120 |
| 13 | 1352 | 28,789,702,656 |
| 14 | 1568 | 36,641,439,744 |
| 15 | 1800 | 45,801,799,680 |
| 16 | 2048 | 56,371,445,760 |
| 17 | 2312 | 68,451,041,280 |
| 18 | 2592 | 82,141,249,536 |
| 19 | 2888 | 97,542,733,824 |
| 20 | 3200 | 114,756,157,440 |
| 21 | 3528 | 133,882,183,680 |
| 22 | 3872 | 155,021,475,840 |
| 23 | 4232 | 178,274,697,216 |
| 24 | 4608 | 203,742,569,600 |
| 25 | 5000 | 231,525,580,800 |
| 26 | 5408 | 261,724,566,600 |
| 27 | 5832 | 294,440,140,800 |
| 28 | 6272 | 329,772,957,696 |
| 29 | 6728 | 367,823,683,584 |
| 30 | 7200 | 408,692,981,760 |
| *Note | | |
| This table refers to the core ciphertext without the added padding The core ciphertext is hidden within padding that may consist of a much larger number of possibilities. Each row in the right column is 256 to the 3rd power and then multiplied by N (N-1)(N-2) where N is the key order The table assumes pre-encryption changes made to at least three places in each polygraphic block according to Principle 2 of the PRACTICAL METHOD FOR CREATING A POLYMORPHIC ENCRYPTION SYSTEM. The number | | |
| # of different potential ciphertext files for nonpolymorphic systems is always 1. | | |

### Description of Operation and General Content of Submitted Program Listing

This description of the operation and general content of the submitted computer program listing appendix is made in accordance with Section 1.96(a) of the Consolidated Patent Rules (CPR). The following directions are given for the operation of the Scrambler system prototype submitted with this application as a computer program listing appendix on CD-R in accordance with Sections 1.96(a) and 1.96(c) of the CPR. The system prototype submitted to the USPTO does not include the password entrance subsystem; activation gives immediate access to the main menu. The system security-administrator internal audit subsystem which generates a coded file has also been disabled.

1. Insert the submitted CD.

2. Click Windows Start.

3. Click Run; use the Run Browser to put D:\Scrambler.exe into the Open window.

4. Click the OK button; the program will load, showing a black screen with the system menu at the top

5. Click “Load keys”; keys must be loaded to system slots before encryption or decryption can begin; a list of key-slot load options will appear; choose one; the system will encrypt or super-encrypt according to your choice; your choice will determine the number and type of keys that are loaded. A set of frames will appear to facilitate key loading.

6. Loading keys on the, system submitted to the USPTO is a little different from those for a normal system; a normal system will be set up to run as a program within the the list of programs in Windows; it will search for keys first on a 1.44 MB diskette, if there is no diskette or if there are no keys on it, the program will search for keys within the program directory where it is located. The USPTO copies are different, do not remove the USPTO CD-R disc copy after the program is loaded; remove the CD-R only after you have exited the program.

7. The USPTO program copies are set to search for keys on the “d.” drive and the keys on the CD-R copy will appear in all the key-list frames. The white list contains substitution keys; the yellow list contains polygraphic/polymorphic encryption keys; the blue list contains polygraphic/polymorphic decryption keys. The encryption and decryption keys are listed from the top down in order of increasing size. Substitution keys have only one size, a substitution key will both encrypt and decrypt.

8. There are three ways to load a key or keys. (a) Manually type the key path and name into the key load frame; the key path here is “d.\”; then click the OK button in the load frame; or (b) Click the desired key in the key-list frame, the key path and name will appear in the proper load frame, then click the OK button in the load frame; or (c) Click the OK button in the Automatic load frame; chosen key slots will be loaded from the top or bottom of the key lists.

9. Limitations on loading keys. All polygraphic/polymorphic encryption and decryption keys must be the same size; the first two numbers in the key name must be the same Encryption and decryption keys loaded to equivalent slots must have the same numbers; encryption and decryption keys having the same numbers are matching-key pairs. After the keys are loaded, the system is ready to encrypt or decrypt. To reset the system slots to allow reloading of different keys or slots, click the “Clear all key slots” suboption near the bottom of the “Load keys” menu option list.

10. The Reverse load button. Located in the polygraphic/polymorphic encoding load frame, the “Reverse load” button is an option facilitating easy loading of encoding keys into decoding slots, and decoding keys into encoding slots. Either key in a matching-key pair will encrypt as long as the other key in the pair is used to decrypt.

11. Both the Encode and Decode options contain suboptions to facilitate easier finding of specific text or graphics files.

12. The system is defaulted to the polymorphic mode It can be set to the polygraphic mode by clicking the “Polygraphic Mode” menu option. When clicked, the “Polygraphic Mode” option becomes the “Polymorphic Mode” option which can be clicked to reset the system back to the more-powerful polymorphic mode.

13. The Save Mode menu option allows the saving of specialized decoded files. The system is defaulted to saving decoded files as text files. The suboptions can save decoded files as sequential files, binary files, random files, or append decoded files to existing files.

14. The Plaintext menu option gives access to a simple word processor that has no overhead; plaintext is created with no extra characters in the file. Decoded files created by more complex word processors must be used by the same word processors by which they were created.

15. The File handler, Fonts, and Colors menu options provide useful system utilities and capabilities.

16. “Polymorphic start vectors.” Located in the “Load keys” list, this suboption provides a frame that facilitates changing of the polymorphic start vectors. Whatever is changed in any program in a communication system must be changed everywhere in the system.

I claim.

1. The Scrambler polygraphic system (Algorithm B) in paragraph [0010] is a new and useful improvement of a known process (Algorithm A) wherein the improvement comprises those shown portions of Algorithm B that allow it (a) to use modulo 256 keys (b) of potentially unlimited size.

2. The principles of a Practical Method for Creating a Polymorphic Encryption System, listed in paragraph [0012], in setting a new encryption standard, is a specific invention which constitutes new and useful improvement on polygraphic systems wherein the improvement comprises (a) the ability to give polygraphic systems polymorphic capability, (b) the ability to give polygraphic systems the capability of hiding repeating patterns of any length, and (c) the ability to give polygraphic systems the capability of clouding, resisting, and masking against traffic analysis based on simple comparison of ciphertext file length

3. The above combined major improvements on the Hill system overcome that system's limitations, creating a new integrated encryption system (the Scrambler system) with extraordinary polymorphic properties never before known to cryptography and the new improved system is to be considered a new and useful process within the meaning of 35 USC section 101.

4. The Table of Improved Hill System Polygraphic/Polymorphic Key Spaces in paragraph [0010] indicating the key spaces available to Algorithm B for a range of key sizes is a specific invention.

5. The Table of Improved Hill System Polymorphic Potential in paragraph [0012] indicating the polymorphic power of Algorithm B combined with improvements drawn from the Practical Method for Creating a Polymorphic Encryption System for a range of key sizes is a specific invention
